(19) United States
(12) Patent Application Publication
(10) Pub. No.: US 2018/0119568 A1
(43) Pub. Date: May 3, 2018

(54) SYSTEMS AND METHODS FOR ATTACHING A BORESCOPE FLEXIBLE PROBE OR A GUIDE TUBE TO A COMPONENT OF A GAS TURBINE

(71) Applicant: General Electric Company, Schenectady, NY (US)

(72) Inventor: Cezar NEGOESCU, Bucharest (RO)

(21) Appl. No.: 15/565,540

(22) PCT Filed: Apr. 10, 2015
(86) PCT No.: PCT/IB2015/000586

§ 371 Date: Oct. 10, 2017

(51) Int. Cl. F01D 21/00; G02B 23/24

(52) U.S. Cl. CPC F01D 21/003; G02B 23/2476

(57) ABSTRACT

A borescope probe or a borescope guide tube holding device attachable to a component of a gas turbine engine is disclosed. In one embodiment, the holding device may include a main body having a first end and a second end. The first end may include a passageway for positioning the borescope probe therethrough. The holding device also may include a fastener assembly positioned on the first end of the main body about the passageway for securing the borescope probe. In addition, the holding device may include a magnetic base positioned on the second end of the main body for attaching the main body to the component of the gas turbine engine. In another embodiment, the holding device may include a guide tube clamping device.

### FIELD

The present disclosure relates generally to borescope examination techniques and more particularly relates to systems and methods for attaching a borescope flexible probe or a borescope guide tube to a component of a gas turbine engine.

### BACKGROUND

It is common to inspect gas turbine engines using what is referred to as a borescope. The borescope probe may be inserted through access ports in the casing or casings of a component of a gas turbine engine to permit viewing of portions of the gas turbine engine, such as compressor or turbine blades. Attaching a borescope probe to a component of a gas turbine engine can be difficult. Often, the borescope probe must be positioned in place for an extended period of time in order to get accurate pictures and/or measurements. Typically, a borescope probe may be held in place by hand, which can be problematic. For example, holding the borescope probe by hand may result in poor quality measurements and/or photographs due to shaking. Moreover, accurate repetition and placement of the borescope probe may be difficult to achieve by hand. Also, in some instances, borescope guide tube may be used when inspecting the turbine components with a borescope. Typically, the borescope guide tube may be held in place by hand, which is not easy and ergonomic for the inspector.

### BRIEF DESCRIPTION

Some or all of the above needs and/or problems may be addressed by certain embodiments of the present disclosure. According to an embodiment, there is disclosed a borescope probe or a borescope guide tube holding device. In one embodiment, a borescope probe holding device is attachable to a component of a gas turbine engine. The holding device may include a main body having a first end and a second end. The first end may include a passageway for positioning the borescope probe therethrough. The holding device also may include a fastener assembly positioned on the first end of the main body about the passageway for securing the borescope probe. Moreover, the holding device may include a magnetic base positioned on the second end of the main body for attaching the main body to the component of the gas turbine engine.

In another embodiment, a borescope probe guide tube holding device is attachable to a component of a gas turbine engine. The holding device may include a magnetic base and a guide tube clamping device attached to the magnetic base.

According to another embodiment, methods of attaching a borescope probe or a borescope guide tube to a component of a gas turbine engine are disclosed. The method may include attaching a magnetic base to the component of the gas turbine engine and attaching a holding device to the magnetic base.

Other embodiments, aspects, and features of the disclosure will become apparent to those skilled in the art from the following detailed description, the accompanying drawings, and the appended claims.

### BRIEF DESCRIPTION OF THE DRAWINGS

Reference will now be made to the accompanying drawings, which are not necessarily drawn to scale.

FIG. 1 schematically depicts a gas turbine engine according to an embodiment.

FIG. 2 schematically depicts a perspective view of an example holding device according to an embodiment.

FIG. 3 schematically depicts a partial cross-sectional side view of an example holding device according to an embodiment.

FIG. 4 schematically depicts a rear view of an example holding device according to an embodiment.

FIG. 5 schematically depicts an exploded view of an example holding device according to an embodiment.

FIG. 6 schematically depicts a perspective view of an example holding device according to an embodiment.

### DETAILED DESCRIPTION

Illustrative embodiments will now be described more fully hereinafter with reference to the accompanying drawings, in which some, but not all embodiments are shown. The present disclosure may be embodied in many different forms and should not be construed as limited to the embodiments set forth herein. Like numbers refer to like elements throughout.

Embodiments of a holding device for securing a borescope probe or a borescope guide tube in place are disclosed herein. Any type of borescope probe or borescope guide tube may be used herein. In some instances, the holding device may be attached to a component of a gas turbine engine. For example, the holding device may be attached to the casing of a compressor, a combustor, and/or a turbine. The holding device may be attached to other components of the gas turbine engine. In some instances, the holding device may be attached near an inspection bore in the casing of the compressor, the combustor, and/or the turbine. In this manner, the holding device may be configured to hold the borescope probe or the borescope guide tube in place about the inspection bore. The holding device may secure the borescope probe or the borescope probe guide tube in an axial and/or radial orientation. The holding device may secure the borescope probe or the borescope guide tube at any location and in any configuration about the gas turbine engine.

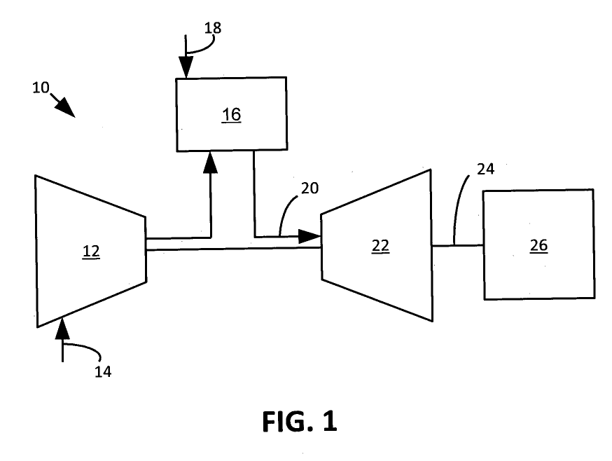

Referring now to the drawings, in which like numerals refer to like elements throughout the several views, FIG. 1 depicts an example schematic view of a gas turbine engine 10 as may be used herein. The gas turbine engine 10 may include a compressor 12. The compressor 12 may compress an incoming flow of air 14. The compressor 12 may deliver the compressed flow of air to a combustor 16. The combustor 16 may mix the compressed flow of air with a pressurized flow of fuel 18 and ignite the mixture to create a flow of combustion gases 20. Although only a single combustor 16 is shown, the gas turbine engine 10 may include any number of combustors 16. The flow of combustion gases 20 may be delivered to a turbine 22. The flow of combustion gases 20 may drive the turbine 22 so as to produce mechanical work. The mechanical work produced in the turbine 22 may drive the compressor 12 via a shaft 24 and an external load 26, such as an electrical generator or the like.

The gas turbine engine 10 may use natural gas, various types of syngas, and/or other types of fuels. The gas turbine engine 10 may be any one of a number of different gas turbine engines offered by General Electric Company of Schenectady, N.Y., including, but not limited to, those such as a 7 or a 9 series heavy duty gas turbine engine and the like. The gas turbine engine 10 may have different configurations and may use other types of components. The gas turbine engine may be an aeroderivative gas turbine, an industrial gas turbine, or a reciprocating engine. Other types of gas turbine engines also may be used herein. Multiple gas turbine engines, other types of turbines, and other types of power generation equipment also may be used herein together.

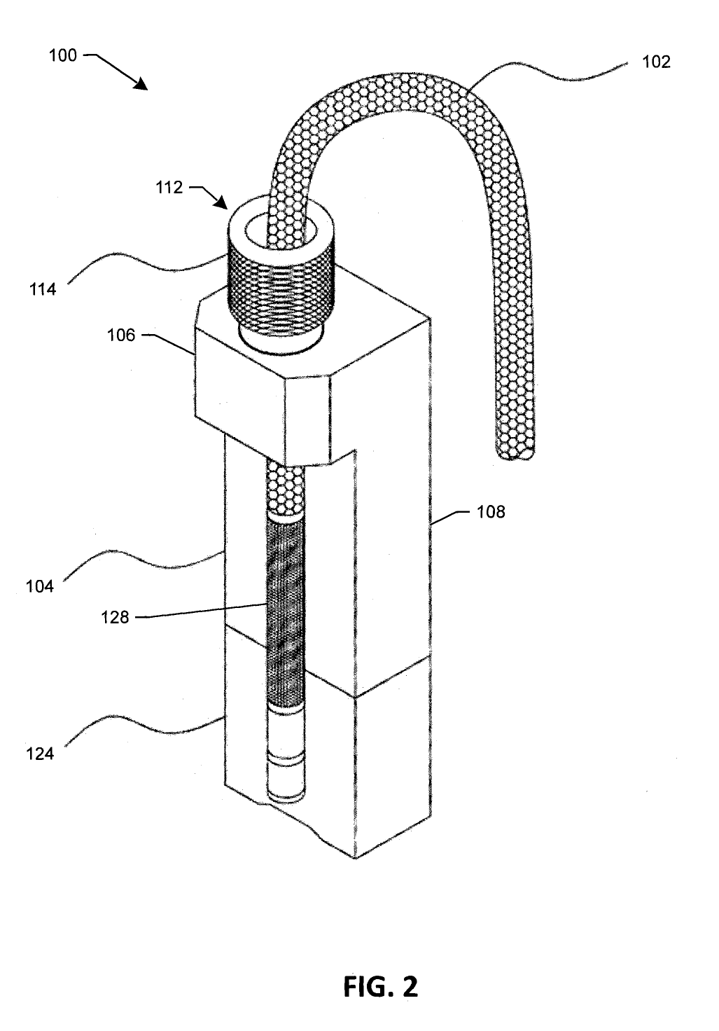

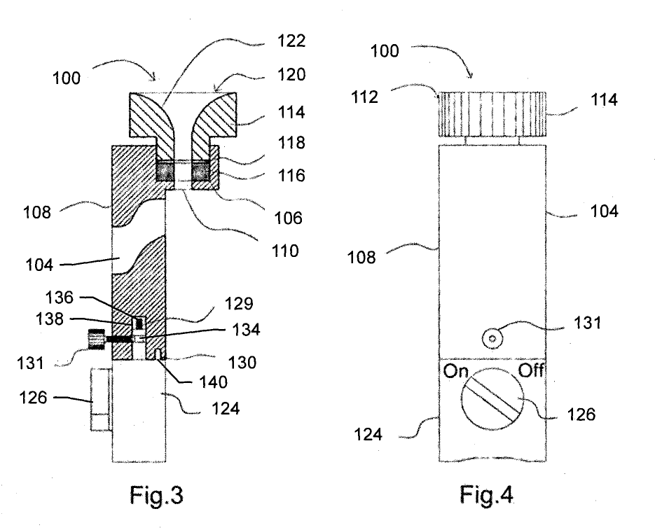

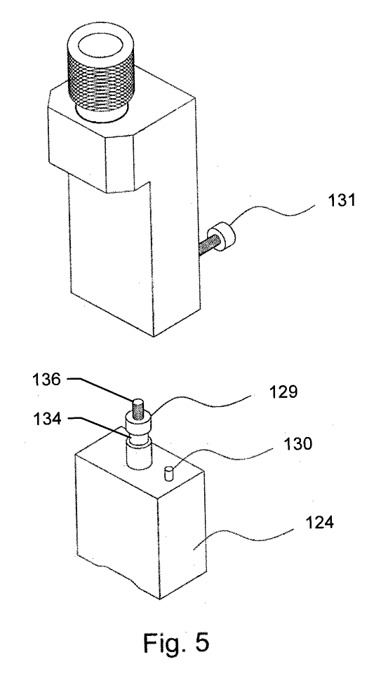

FIGS. 2-6 show a borescope probe or a borescope guide tube holding device 100 as may be used herein. The holding device 100 may be attached to a component of a gas turbine engine. In some instances, the holding device 100 may be used to secure a borescope probe 102 in place. In certain embodiments, the holding device 100 may include an L-shaped main body 104. The L-shaped main body 104 may include a short side 106 and a long side 108. The short side 106 may include a passageway 110 for positioning the borescope probe 102 therethrough.

The holding device 100 may include a gland nut assembly 112 positioned on the short side 106 of the main body 104 about the passageway 110 for securing the borescope probe 102. Any fastener assembly may be used. The gland nut assembly 112 may include a gland nut 114, a sealing ring 116, and a washer 118. The washer 118 may be disposed between the gland nut 114 and the sealing ring 116 to decrease friction therebetween. In certain embodiments, the sealing ring 116 may be a rubber square ring. The sealing ring 116 may be positioned around at least a portion of the borescope probe 102. In this manner, the gland nut 114 may be tightened so as to compress the sealing ring 116 about the borescope probe 102, thereby securing the borescope probe 102 in place. Conversely, the gland nut 114 may be loosened to release the sealing ring 116 about the borescope probe 102 so as to enable the borescope probe 102 to be reconfigured.

The gland nut 114, the washer 118, and the sealing ring 116 may form an opening 120 for positioning the borescope probe 102 therethrough. In some instances, the opening 120 of the gland nut 114 may include a chamfer or fillet 122 to avoid bending of the borescope probe 102. That is, an outer portion of the opening 120 in the gland nut 114 may include a larger radius than an inner portion of the opening 120 in the gland nut 114.

The holding device 100 may include a detachable magnetic base 124. In some instances, the magnetic base 124 may include a permanent magnet. For example, the magnetic base 124 may include a toggle 126 for manipulating the permanent magnet. The toggle 126 may include an on position for securing the magnetic base 124 to a component of a gas turbine engine. The toggle 126 also may include an off position, in which the force of the permanent magnet may become almost zero and the magnetic base 124 may be removed. In some instances, the magnetic base 124 may be positioned on the long side 108 of the main body 104. The magnetic base 124 may be attached to a casing of a component of the gas turbine engine near an inspection bore.

In some instances, the magnetic base 124 may be removably attached to the main body 104. For example, the magnetic base 124 may include a bolt 129 with a groove 134 and a threaded end 136. The main body 104 may include a slot 138 configured to mate with the bolt 129. The main body 104 also may include a knob 131 in communication with the slot 138 in the main body 104. The knob 131 can be threaded into the groove 134 of the bolt 129 to secure the main body 104 to the magnetic base 124. In this manner, when the knob 131 is loosening out of the groove 134 in the bolt 129, the main body 104 can be removed from magnetic base 124. The magmatic base 124 may include a pin 130 configured to mate with a corresponding slot 140 in the main body 104 for proper alignment of the magnetic base and the main body 104.

In certain embodiments, the borescope probe 102 may include an angulation portion 128. The angulation portion 128 may enable the tip (or other portion) of the borescope probe 102 to bend at an angle. A length of the main body 104 may be at least as long as the angulation portion 128 of the borescope probe 102. For example, the long side 108 of the L-shaped main body 104 may be at least as long as the angulation portion 128 of the borescope probe 102.

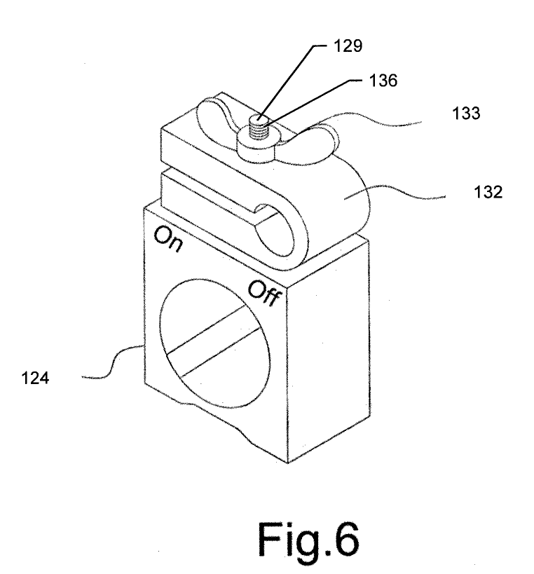

As depicted in FIG. 6, the magmatic base 124 can also be attached to a guide tube clamping device 132. The guide tube clamping device 132 may be configured to clamp a borescope guide tube therein. In some instances, the guide tube clamping device 132 may be a steel spindle adjusting collar. The guide tube clamping device 132 may be any type of clamping device. The guide tube clamping device 132 may be attached to the bolt 129 of the magnetic base 124 by way of a nut 133. For example, the nut 133 may be threaded onto and/or off of the threaded end 136 of the bolt 129. The nut 133 may be tightened or loosened by hand. In some instances, the nut 133 may be a butterfly nut. The nut 133 may be any type of fastener. When the nut 133 is loosening, a borescope guide tub may be inserted through the spindle collar. Conversely, when the nut 133 is tightened, the borescope guide tube may be locked in a desired position.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

1. A borescope probe holding device attachable to a component of a gas turbine engine, the holding device comprising:
a main body having a first end and a second end, wherein the first end comprises a passageway for positioning the borescope probe therethrough;
a fastener assembly positioned on the first end of the main body about the passageway for securing the borescope probe; and
a magnetic base positioned on the second end of the main body for attaching the main body to the component of the gas turbine engine.

2. The holding device of claim 1, wherein magnetic base is detachable from the main body.

3. The holding device of claim 1, wherein magnetic base comprises a bolt having a groove and a threaded end.

4. The holding device of claim 3, wherein the main body comprises a slot configured to mate with the bolt and a knob configured to engage the groove.

5. The holding device of claim 1, wherein the main body comprises an L-shaped main body having a short side and a long side.

6. The holding device of claim 5, wherein the fastener assembly is disposed on the short side of the L-shaped main body.

7. The holding device of claim 5, wherein the magnetic base is disposed on the long side of the L-shaped main body.

8. The holding device of claim I, wherein an opening of the fastener assembly comprises a chamfer or fillet.

9. The holding device of claim 1, wherein the magnetic base comprises a permanent magnet which can be manipulated to an on position to maintain the magnetic base in place or deactivated to an off position to disengage the magnetic base.

10. The holding device of claim 1, wherein a length of the main body is at least as long as an angulation portion of the borescope probe.

11. A borescope guide tube holding device attachable to a component of a gas turbine engine, the holding device comprising:
a magnetic base; and
a guide tube clamping device attached to the magnetic base.

12. The holding device of claim 11, wherein the magnetic base is detachable from the guide tube clamping device.

13. The holding device of claim 11, wherein the magnetic base comprises a bolt having a threaded end.

14. The holding device of claim 13, wherein the guide tube clamping device is attachable to the bolt by way of a nut.

15. The holding device of claim 14, wherein the nut comprises a butterfly nut.

16. The holding device of claim 14, wherein adjusting the nut adjusts a clamping force of the guide tube clamping device.

17. The holding device of claim 11, wherein the guide tube clamping device comprises a spindle adjusting collar.

18. A method of attaching a borescope probe or a borescope guide tube to a component of a gas turbine engine, the method comprising:
attaching a magnetic base to the component of the gas turbine engine; and
attaching a holding device to the magnetic base.

19. The method of claim 18, wherein the holding device comprises:
a main body having a first end and a second end, wherein the first end comprises a passageway for positioning the borescope probe therethrough; and
a fastener assembly positioned on the first end of the main body about the passageway for securing the borescope probe.

20. The method of claim 18, wherein the holding device comprises a guide tube clamping device.
